(19) United States
(12) Patent Application Publication
(10) Pub. No.: US 2026/0080403 A1
(43) Pub. Date: Mar. 19, 2026

(54) SECURING ACCESS DATA USE WITH DEVICE DATA

(71) Applicant: Visa International Service Association, San Francisco, CA (US)

(72) Inventors: Sandeep Tharoor, Palakkad (IN); Hunny Huria, Singapore (SG)

(73) Assignee: Visa International Service Association, San Francisco, CA (US)

(21) Appl. No.: 18/887,925

(22) Filed: Sep. 17, 2024

(51) Int. Cl. G06Q 20/40; G06Q 20/32

(52) U.S. Cl. CPC G06Q 20/401; G06Q 20/3226

(57) ABSTRACT

A method is disclosed. The method includes receiving, by a portable device with access data from a user device, a communication including user device data using NFC (near field communications), and determining, by the portable device using the user device data received from the user device, whether the user device is authorized to receive the access data. If the user device is authorized to receive the access data, then providing, by the portable device the access data to the user device. The user device initiates an interaction with an external computer using the access data.

### CROSS-REFERENCES TO RELATED APPLICATIONS

None.

### BACKGROUND

Unauthorized persons can obtain access data such as account numbers in many different ways. Access data such as account numbers can be obtained through phishing, data breaches, card skimming, lost or stolen cards, malware or spyware, and scam phone calls. The fraud that results from stolen account information in the payments card industry alone is in the billions of dollars.

There is a need to improve data security with respect to access data and to protect the access data from unauthorized use.

Embodiments of the invention address these and other problems, individually and collectively.

### SUMMARY

One embodiment includes a method comprising: receiving, by a portable device comprising access data from a user device, a communication comprising user device data; determining, by the portable device using the user device data received from the user device, whether the user device is authorized to receive the access data; and if the user device is authorized to receive the access data, then providing, by the portable device the access data to the user device, wherein the user device initiates an interaction with an external computer using the access data.

Another embodiment of the invention includes a portable device comprising: a processor; and a non-transitory computer readable medium comprising code, executable by the processor to perform a method comprising: receiving, by a portable device comprising access data from a user device, a communication comprising user device data, determining, by the portable device using the user device data received from the user device, whether the user device is authorized to receive the access data, and if the user device is authorized to receive the access data, then providing, by the portable device the access data to the user device, wherein the user device initiates an interaction with an external computer using the access data.

Another embodiment includes a method comprising: receiving, by a user device comprising an application from a portable device, access data; signing, by the user device, information including the access data using a first cryptographic key associated with a key pair to obtain a digital signature; transmitting, by the user device to an authentication server computer, the digital signature and the information including the access data, wherein the authentication server computer verifies the digital signature with a second cryptographic key; receiving, by the user device, from the authentication server computer, an authentication indicator; and initiating, by the user device, the sending of an authorization request message comprising the access data and the authentication indicator to an external computer.

Another embodiment of the invention includes a user device comprising a processor, and a computer readable medium coupled to the processor. The computer readable medium comprises code, executable by the processor, for performing a method comprising: receiving, by a user device comprising an application from a portable device, access data; signing, by the user device, information including the access data using a first cryptographic key associated with a key pair to obtain a digital signature; transmitting, by the user device to an authentication server computer, the digital signature and the information including the access data, wherein the authentication server computer verifies the digital signature with a second cryptographic key; receiving, by the user device, from the authentication server computer, an authentication indicator; and initiating, by the user device, the sending of an authorization request message comprising the access data and the authentication indicator to an external computer.

These and other embodiments are described in further detail below.

### BRIEF DESCRIPTION OF THE DRAWINGS

FIG. 1 shows a system and a flow diagram according to an embodiment of the invention.

FIG. 2 show a diagram of a portable device according to an embodiment.

FIG. 3 shows a diagram of a user device according to an embodiment.

FIG. 4 shows a diagram of an interaction message flow between a portable device and a user device according to an embodiment.

FIG. 5A shows a system and a flow diagram illustrating a registration process according to an embodiment.

FIG. 5B shows a system and a flow diagram illustrating a transaction process according to an embodiment.

FIG. 6 shows a block diagram of a device verification computer according to an embodiment.

FIG. 7 shows a block diagram of an authentication computer according to an embodiment.

### DESCRIPTION

Prior to discussing embodiments of the disclosure, some terms can be described in further detail.

A “user” may include an individual. In some embodiments, a user may be associated with one or more personal accounts and/or mobile devices. The user may also be referred to as a cardholder, account holder, or consumer in some embodiments.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network. A user device may also be a credit, debit, or prepaid card.

A "portable device" can be a device that is easily transportable. In some cases, it can be hand-held and compact. For example, a portable device may fit into a user's wallet and/or pocket (e.g., pocket-sized). Some exemplary portable devices may include smart cards, ordinary credit or debit cards (with a magnetic strip), keychain devices, etc. Other examples of portable devices include cellular phones, personal digital assistants (PDAs), pagers, payment cards, security cards, access cards, smart media, transponders, vehicles (e.g., cars, boats, motorcycles, etc.), wearable devices (e.g., smart watch, smart jewelry, smart clothing, etc.) and the like. The portable devices can also be debit devices (e.g., a debit card), credit devices (e.g., a credit card), or stored value devices (e.g., a stored value card).

An “antenna” can include a device used to transmit and/or receive signals. An antenna can be a rod, a wire, a chip, a chipset, etc. that is capable of receiving and/or transmitting radio signals. An antenna can be a near-field communication antenna, an ultra-wideband antenna, or any other suitable type of antenna.

A “near-field communication antenna” can include a device used to transmit and/or receive near-field communication based signals. A near-field communication antenna can be a chip or a chipset that enables short-range wireless communication between two devices. A near-field communication antenna can be a near-field communication reader chip (e.g., active component) or a near-field communication tag (e.g., passive component). A near-field communication antenna that is a near-field communication reader chip can provide power and can send near-field communication commands to a near-field communication tag. Near-field communication is based on inductive coupling between two antennas present on two devices (e.g., on a user device and on an access device). The two devices can communicate in one or both directions, using a frequency of 13.56 MHz in the globally available unlicensed radio frequency ISM band using the ISO/IEC 14443 air interface standard at data rates ranging from 106 to 848 kbit/s.

An “application” may be computer code or other data stored on a computer readable medium that may be executable by a processor to complete a task.

"Access data" may include any suitable data that can be used to access a resource or create data that can access a resource. In some embodiments, access data may be account information for a payment account. Account information may include a credential such as a PAN, a token such as a payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

A “credential” may be any suitable information that serves as reliable evidence of worth, ownership, identity, or authority. A credential may be a string of numbers, letters, or any other suitable characters, as well as any object or document that can serve as confirmation. Examples of credentials include value credentials, identification cards, certified documents, access cards, passcodes and other login information, etc.

A “token” may be a substitute value for a credential. A token may be a string of numbers, letters, or any other suitable characters. Examples of tokens include access tokens such as payment tokens, data that can be used to access secure systems or locations, etc.

A "payment token” may include an identifier for a payment account that is a substitute for an account identifier, such as a primary account number (PAN) and/or an expiration date. For example, a token may include a series of alphanumeric characters that may be used as a substitute for an original account identifier. For example, a token “4900000000000001” may be used in place of a PAN “4147090000001234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real credential (e.g., a primary account number (PAN)) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “cryptogram” may include a piece of obscured text such as encrypted text. A cryptogram may be formed by encrypting input data with an encryption key such as a symmetric encryption key. In some embodiments, a cryptogram is reversible so that the inputs that are used to form the cryptogram can be obtained using the same symmetric key to perform a decryption process. In some embodiments, if input data is encrypted using a private key of a public/private key pair, the cryptogram may also be a digital signature. A digital signature may be verified with a public key of the public/private key pair. In some embodiments, a cryptogram may include a dCVV (dynamic card verification value).

A “resource provider” may be an entity that can provide a resource such as goods, services, information, and/or access. Examples of resource providers includes merchants, data providers, transit agencies, governmental entities, venue and dwelling operators, etc. A “merchant” may typically be an entity that engages in transactions and can sell goods or services, or provide access to goods or services.

An “authorizing entity” may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer, or in some embodiments, a portable device.

An “authorization request message” may be an electronic message that requests authorization for an interaction. In some embodiments, it is sent to a transaction processing computer and/or an issuer of a payment card to request authorization for a transaction. An authorization request message according to some embodiments may comply with International Organization for Standardization (ISO) 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction value, merchant identifier, merchant location, acquirer bank identification number (BIN), card acceptor ID, information identifying items being purchased, etc., as well as any other information that may be utilized in determining whether to identify and/or authorize a transaction.

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

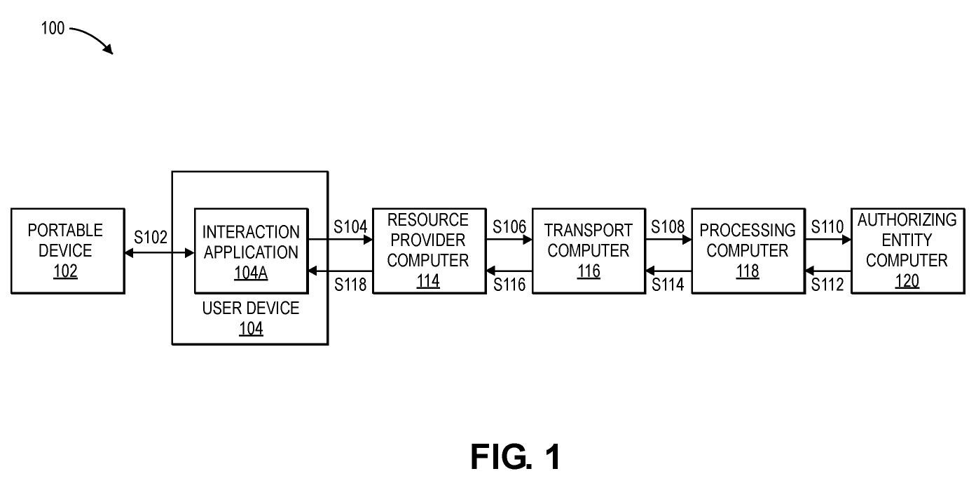

FIG. 1 shows a system and an overlaid method according to an embodiment of the invention. The system in FIG. 1 includes a portable device 102 and a user device 104, which can communicate with each other (e.g., via NFC) and can be owned and operated by the same user. In some embodiments, the portable device 102 can be in the form of a card such as a payment card, and the user device 104 can be in the form of a communication device such as a mobile phone. The user device 104 can communicate with external computers such as a resource provider computer 114, a transport computer 116, a processing computer 118, and/or an authorizing entity computer 120.

The resource provider computer 114 can be in communication with the authorizing entity computer 120 via the transport computer 116 (which may be an acquirer computer operated by an acquirer) and the processing computer 118. The processing computer 119 may include data processing subsystems, networks, and operations used to support and deliver authorization services, exception file services, transaction scoring services, and clearing and settlement services. An exemplary payment processing network may include VisaNet™. Transaction processing systems such as VisaNet™ are able to process credit card transactions, debit card transactions, and other types of commercial transactions. VisaNet™, in particular, may include a VIP system (Visa Integrated Payments system) which processes authorization requests and a Base II system which performs clearing and settlement services.

The authorizing entity computer 120 can be operated by an authorizing entity such as an issuer, which issues the portable device 102 to the user.

Each of the entities in FIG. 1 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

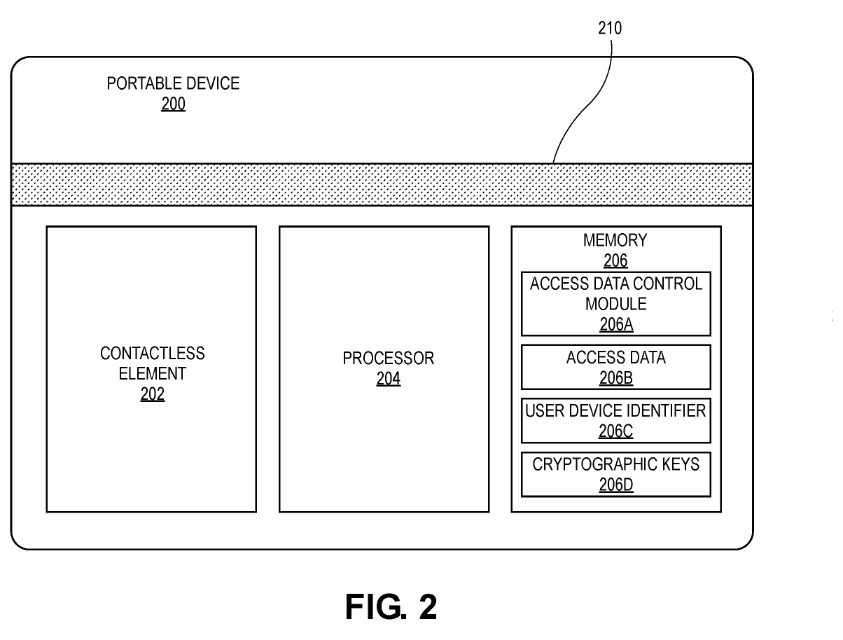

FIG. 2 shows a block diagram of a portable device 200 according to an embodiment in the form of a card. If it is a card, the card can have embossed information such as an account number and expiration date on it. The card can be a payment card such as a debit, credit, or stored value card, or a government issued ID card or employee access card.

The portable device 200 may also comprises a processor 204 and a memory 206. The memory 206 can store an access data control module 206A, access data 206B, a user device identifier 206C, and cryptographic keys 206D. The access data control module 206A can allowing for the release and transmission of the access data 206B if the user device identifier of the user device that it is interacting with is the same as the user device identifier 206C. The access data 206B and the user device identifier 206C may be preloaded into the portable device 200 by the authorizing entity (e.g., an issuer) that issued the portable device 200 to the user. The cryptographic keys 206D can be used for signing or verifying signed data.

The portable device 200 can include a contactless element 202 coupled to the processor 204. The contactless element 202 can comprise an RF ID reader or other wireless reader and any associated electronics. The contactless element 202 can allow the portable device 200 to communicate contactlessly with an external device such as a user device or an access device. The portable device 200 may also have a magnetic stripe 210 storing the access data, or electrical contacts (not shown) that are coupled to the processor 204. The electrical contacts can allow the processor 204 to communicate with external devices in a contact mode.

The memory 206 can also comprise a computer readable medium coupled to the processor 204. The computer readable medium comprises access data and code executable by the processor for performing a method comprising: receiving, from a user device, a communication comprising user device data; determining, using the user device data received from the user device, whether the user device is authorized to receive the access data; and if the user device is authorized to receive the access data, then providing the access data to the user device, wherein the user device initiates an interaction with an external computer using the access data.

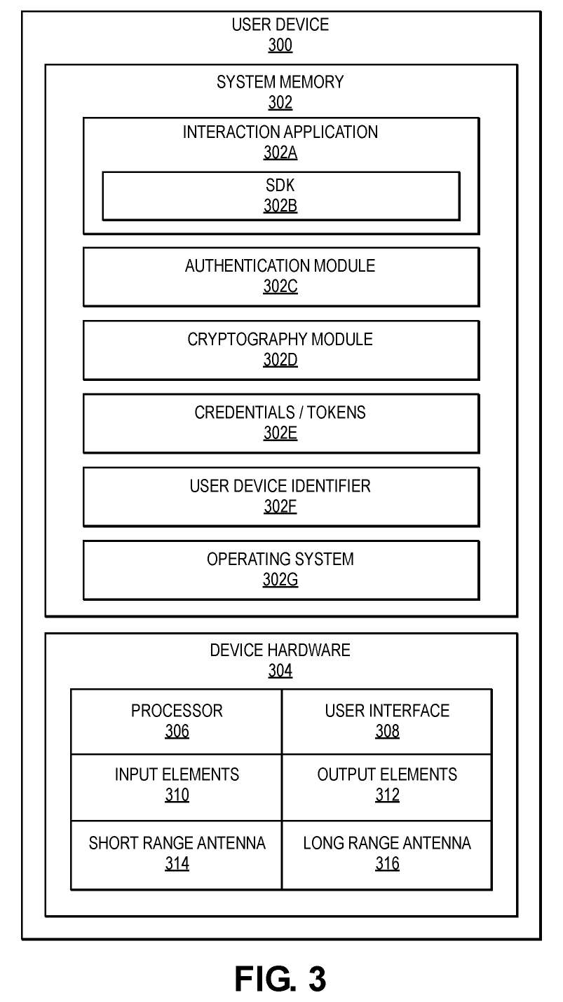

FIG. 3 illustrates a block diagram of a user device 300 according to an embodiment. User device 300 may include device hardware 304 coupled to a system memory 302.

Device hardware 304 may include a processor 306, a short range antenna 314, a long range antenna 316, input elements 310, a user interface 308, and output elements 312 (which may be part of the user interface 308). Examples of input elements may include microphones, keypads, touchscreens, sensors, etc. Examples of output elements may include speakers, display screens, and tactile devices. The processor 306 can be implemented as one or more integrated circuits (e.g., one or more single core or multicore microprocessors and/or microcontrollers), and is used to control the operation of user device 300. The processor 306 can execute a variety of programs in response to program code or computer-readable code stored in the system memory 302, and can maintain multiple concurrently executing programs or processes.

The long range antenna 316 may include one or more RF transceivers and/or connectors that can be used by user device 300 to communicate with other devices and/or to connect with external networks. The long range antenna 316 may be configured to communicate with a remote base station and a remote cellular or data network, over the air. The short range antenna 314 may be configured to communicate with external entities through a short range communication medium (e.g., using Bluetooth, Wi-Fi, infrared, NFC, etc.). The user interface 308 can include any combination of input and output elements to allow a user to interact with and invoke the functionalities of user device 300.

The system memory 302 can be implemented using any combination of any number of non-volatile memories (e.g., flash memory) and volatile memories (e.g., DRAM, SRAM), or any other non-transitory storage medium, or a combination thereof media. The system memory 302 may store computer code, executable by the processor 805, for performing any of the functions described herein. For example, the system memory 302 may comprise a computer readable medium comprising code, executable by the processor 306, for implementing methods according to embodiments.

The system memory 302 may also store an interaction application 302A with an SDK 302B, an authentication module 302C, a cryptography module 302D, access data such as credentials/tokens 302E, a user device identifier 302F and an operating system 302G, The interaction application 302A can be a merchant application, an issuer application, a digital wallet application, etc. The authentication module 302C may comprise code, executable by the processor 306, to authenticate a user. This can be performed using user secrets (e.g., passwords) or user biometrics. The cryptography module 302D may include cryptographic keys and algorithms for cryptographic operations such as encryption, signing and signature verification.

The system memory 302 may also store access data such as credentials/tokens 302E and one or more user device identifiers 302F. The system memory 302 may also store software for an operating system 302G.

The system memory 302 may also comprise a computer readable medium, comprising code, executable by the processor 306 to perform a method comprising: receiving, by the user device comprising an application from a portable device, access data; signing, by the user device, information including the access data using a first cryptographic key associated with a key pair to obtain a digital signature; transmitting, by the user device to an authentication server computer, the digital signature and the information including the access data, wherein the authentication server computer verifies the digital signature with a second cryptographic key; receiving, by the user device, from the authentication server computer, an authentication indicator; initiating, by the user device, the sending of an authorization request message comprising the access data and the authentication indicator to an external computer.

A method can be described with reference to FIG. 1. The user of the portable device 102 and the user device 104 may wish to perform an interaction with a resource provider operating the resource provider computer 114. The user may use the interaction application 104A on the user device 104 to communicate with a resource provider operating the resource provider computer 114. In some embodiments, the interaction application can be a browser or an application such as a resource provider application. In some embodiments, the resource provider could be a merchant or an entity that allows access to secure data or a secure location. The resource provider computer 114 can be a merchant server that operates a merchant Website, or it could be an application server that supports the interaction application 104A. In an embodiment, the user can select goods or services to purchase on the merchant Website or via a merchant application.

Although a purchase transaction is described in detail for purposes of illustration, in other embodiments, a purchase transaction does not need to take place. For example, instead of a purchase transaction, the transaction can be a transaction to obtain access to secure data (e.g., personal records stored in a database) or access to a secure location.

In step S102, after selecting the resources to be obtained, the resource provider computer 114, via the interaction application 104A may prompt the user to interact the portable device 102 with the user device 104. The user may place the portable device 102 near the user device 104 and they can communicate using a protocol such as NFC (near field communication). For example, the user may tap the portable device 102 near an NFC reader in the user device 104. In another example, the portable device 102 may be a card and the user device 104 is a mobile phone. The portable device 102 is placed inside of a phone case that holds the phone. The portable device 102 is positioned so that its NFC antenna is proximate to the NFC antenna in the user device 104 while they are both in the phone case. The interaction application 104A, when activated, can turn the user device 104 NFC reader on to communicate with the portable device 102 without the need to move the portable device 102.

In the interaction, the user device 104 can pass a user device identifier to the portable device 102. The portable device 102 can use an access data control module to determine if the user device 104 is authorized to receive the access data. For example, the portable device 102 can determine if the user device identifier matches the user device identifier stored in the portable device 200. If it does, then the portable device 102 can transmit the access data to the interaction application 104A in the user device 104.

The user device identifier can be a unique identifier associated with the user device 104. For example, the user device identifier could be a phone number, IMEI number, secure element identifier, manufacturer ID, or a specific identifier created by another entity. If the user device identifier is a specific identifier created by another entity, then the another entity can be an authorizing entity (e.g., an issuer) that operates the authorizing entity computer 120, an acquirer that operates the transport computer 116, or a processing organization that operates the processing computer 118. In some embodiments, the entity can issue the user device identifier after registering the user device 104, and confirming that the user device 104 is capable of conducting transactions with the portable device 102. The user device identifier can be loaded into a memory of the portable device 102 during or after it is manufactured.

The user device identifier is an example of user device data. Another example of user device data can be a digital signature that is produced by the user device. In such embodiments, the portable device 102 can store a cryptographic key that can verify the signature. If the signature is verified, then the portable device 102 an transmit the access data to the interaction application 104A in the user device 104.

In step S104, the interaction application 104A may then pass the access data to the resource provider computer 114. The resource provider computer 114 can then generate an authorization request message and transmit it to the authorizing entity computer 120 via the transport computer 116, and the processing computer 118 in steps S106, S108, and S110. The authorizing entity computer 120 can then decide whether or not to authorize the transaction, and can generate an authorization response message. The authorizing entity computer 120 can then transmit the authorization response message to the resource provider computer 114 via the processing computer 118 and the transport computer 116.

At step S118, the resource provider computer 114 can provide an indication that the transaction was authorized in step S118.

At the end of the day or any other suitable period of time, a clearing and settlement process can occur between the transport computer 116, the processing computer 118, and the authorizing entity computer 120.

If the access data in the authorization request message is a token, then the processing computer 118 can de-tokenize the token and modify the authorization request message to include the credential associated with the token. The modified authorization request message can then be transmitted to the authorizing entity computer 120. The authorizing entity computer 120 can then transmit an authorization response message comprising the credential back to the processing computer 118. The processing computer 118 can then re-tokenize the credential and can modify the authorization response message to include the token. The processing computer 118 can then transmit the modified authorization response message back to the resource provider computer 114 via the transport computer 116.

The embodiments described with respect to FIG. 1 have a number of advantages. For example, in such embodiments, the portable device 102 does not transmit sensitive access data to the user device 104 unless the user device 104 is authorized to receive the access data. As such, an entity that obtains the access data through illegitimate means cannot use the access data to conduct interactions, since the entity does not have the user device 104. The sensitive access data is thereby protected.

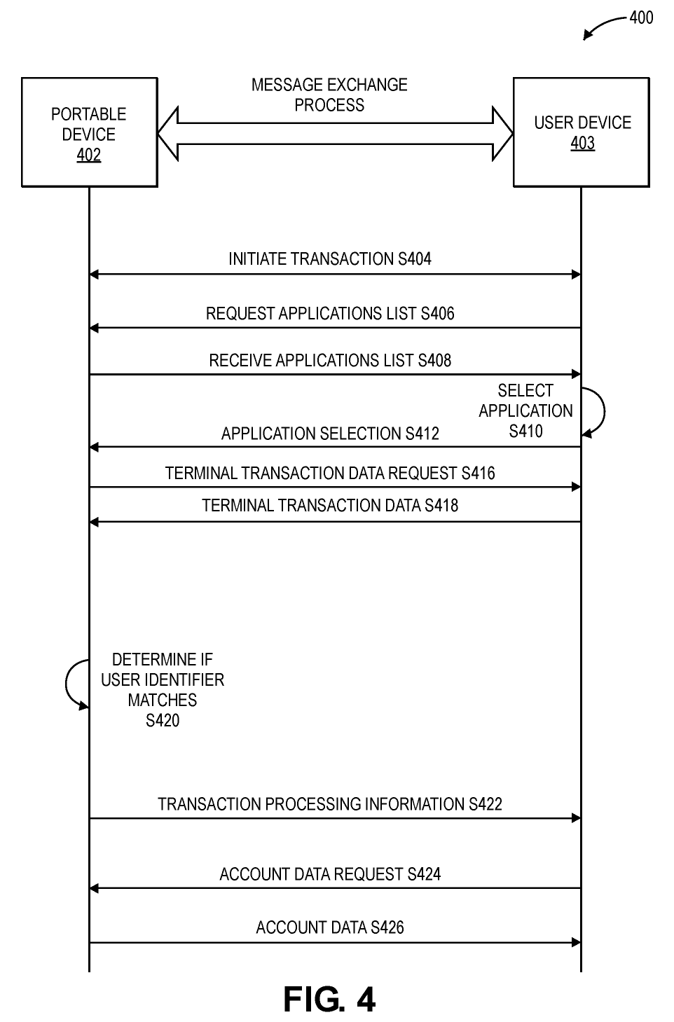

A message exchange process between an exemplary portable device 402 and a user device 403 is shown in FIG. 4. The portable device 402 can correspond to the portable device 102 in FIG. 1. The user device 403 can correspond to the user device 104 in FIG. 1.

Prior to performing the message exchange process, an authorizing entity (e.g., an issuer, the user’s bank, etc.) may initialize the portable device 402 with a number of data fields (e.g., as part of a process for personalization of the portable device 402). The portable device 402 may be configured with one or more applications. The portable device 402 may store additional sensitive access data such as a credential such as a PAN (primary account number), a CVV, an expiration date, and any other suitable information. The access data may also comprise a token instead of a credential. The portable device 402 can also store the previously described user device identifier.

At step S404, a user can subsequently use the portable device 402 to initiate a transaction request with the user device 403. The user may hold the portable device 402 near the user device 403, such that both devices may mutually detect each other and exchange data.

During a process for exchanging data between the portable device 402 and the user device 403, the portable device 402 may provide the user device 403 with a list of available applications. In an interaction, in step S406, the user device 403 may send an available applications request message to the portable device 402. The available applications request message can request information regarding which applications (e.g., a list of application identifiers (AIDs)) are available on the portable device 402. In some embodiments, the available applications request message may be in the form of a SELECT PPSE command.

At step S408, the portable device 402 then identifies, from a memory of the portable device, available applications. The portable device 402 then provides (e.g., transmits) an available applications response message to the user device 403. The available applications response message includes the list of the applications (e.g., a list of AIDs) available at the portable device 402 in a SELECT PPSE response in response to receiving the SELECT PPSE command. The available applications response message can comprise an application list comprising at least a first application and a second application. The application list can be ordered according to a first priority and a second priority to indicate a preference for the user device 403 to use the first application over the second application to process the interaction.

As shown in step S410, the user device 403 selects an application from the received application list, and then transmits the selection of the application in a select AID message to the portable device 402 (step S412). In some embodiments, the user device 403 selects the application highest in the list (e.g., the application associated with the highest priority, in this case the first application). If the interaction is a payment transaction, then this process for application selection may conform to a payment standard such as EMV 1.0 and/or EMV 2.0.

At step S416, the portable device 402 may transmit a request for terminal transaction data (e.g., a PDOL request). In some embodiments, the terminal transaction data request may be in the form of a “Select AID Response” and may include application identifier (AID) and file control information (FCI) associated with the selected AID as the dedicated file name. The terminal transaction data request may include a list of transaction data identifiers to request the appropriate data from the user device 403. The list of transaction data identifiers can be in the form of a processing options data object list (PDOL).

At step S418, responsive to the request for terminal transaction data, the user device 403 may send terminal transaction data to the portable device 402. The transaction data requested by the portable device 402 for the transaction may include terminal processing options (TPO), an amount, and other information. In addition, the transaction data may include one or more dynamic data elements (e.g., a random number), an identifier for the resource provider, the user device identifier associated with the user device 403, etc.

In some embodiments, the terminal transaction data may be sent in the form of a get processing options (GPO) command, and may include the requested terminal transaction data in a processing options data object list (PDOL). The terminal transaction data (e.g., Transaction Processing Options (TPO)) may include a TPO indicator that indicates which transaction data types of the user device 403 supports.

At step S420, the portable device 402 can determine if the user device identifier received from the user device 403 matches a user device identifier stored in the portable device 402. If it does, then the method can proceed to step S422. If it does not, then an error message may be sent from the portable device 402 to the user device 403 and the access data on the portable device 402 will not be sent to the user device 403.

At step S422, the portable device 402 may obtain relevant credentials (e.g., card credentials) or other access data, and may send a set of transaction processing information to the user device 403. In some embodiments, the transaction processing information can be sent in the form of a “get processing options” (GPO) response. In some embodiments, the transaction processing information may include one or more application file locators (AFLs) that can be used as file addresses by user device 403 to read account data stored on the portable device 402, and an application interchange profile (AIP) that can be used to indicate the capabilities of the payment application.

The transaction processing information may include any credentials (or tokens) for the transaction including a cryptogram generated using transaction information, Track-2 equivalent data (e.g., PAN, expiration date), and/or additional data. For example, the cryptogram may be generated using transaction information, which may include a dynamic data element (e.g., the random number), the portable device 402 identifier (e.g., a PAN), and optionally other information such as a session identifier, a value such as a zero dollar amount, and a transaction counter. The transaction processing information may also include issuer application data (IAD), a form factor indicator (FFI), card transaction qualifiers (CTQ), cryptogram information data (CID), and/or an application PAN sequence number (PAN). In some embodiments, the issuer application data (IAD) may include a length indicator indicating the length of the IAD, a cryptogram version number (CVN) indicating the version of the transaction cryptogram, a derived key indicator (DKI) that can be used to identify a master key (e.g., a master key associated with the issuer), and/or card verification results (CVR).

In some embodiments, after the user device 403 receives the transaction processing information, in step S424, the user device 403 may send an account data request to the portable device 402 to read additional account data that may be stored on the portable device 402. In some embodiments, the account data request may be in the form of a “read record” command, and may include an application file locator (AFL) indicating a location of the account data that the user device 403 is attempting to read. The AFL included in the account data request may correspond to an AFL in the transaction processing information that was provided to the user device 403 from portable device 402.

In response to receiving the account data request from the user device 403 in step S426, the portable device 402 may send account data stored at the location indicated by the AFL to the user device 403. In some embodiments, the account data may be sent in the form of a “read record” response. The account data may include, for example, application usage control that indicates the issuer’s restrictions on usage and services allowed for the application, the cardholder’s name, customer exclusive data, issuer country code, and/or other account related data that is accessible at the AFL location and is stored in the portable device 402. The account data, transaction processing information, and other data received by the user device 403 in previous steps may be subsequently used by the user device 403 to complete the payment transaction.

At some point, the user may remove the portable device 402 from the user device 403, or otherwise disengage the portable device 402 from the user device 403. Upon removal or disengagement, the portable device 402 may be powered off which also powers off the volatile memory of the portable device 402, clearing the flag previously set on the portable device 402.

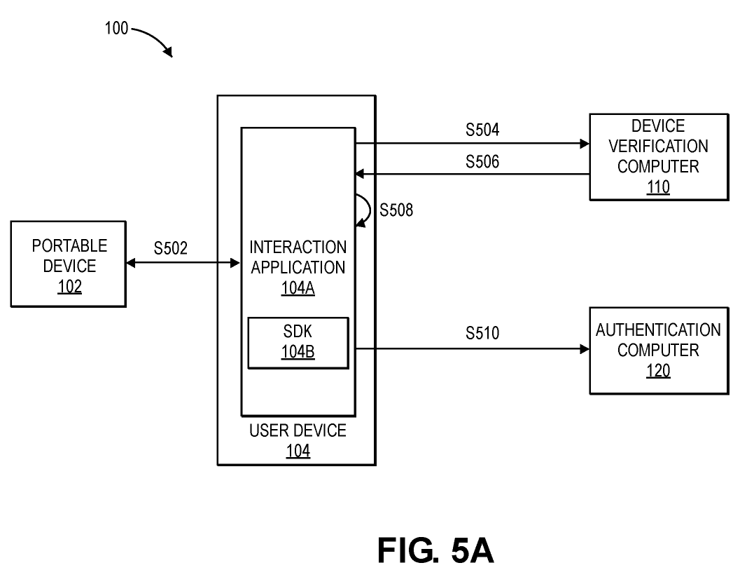

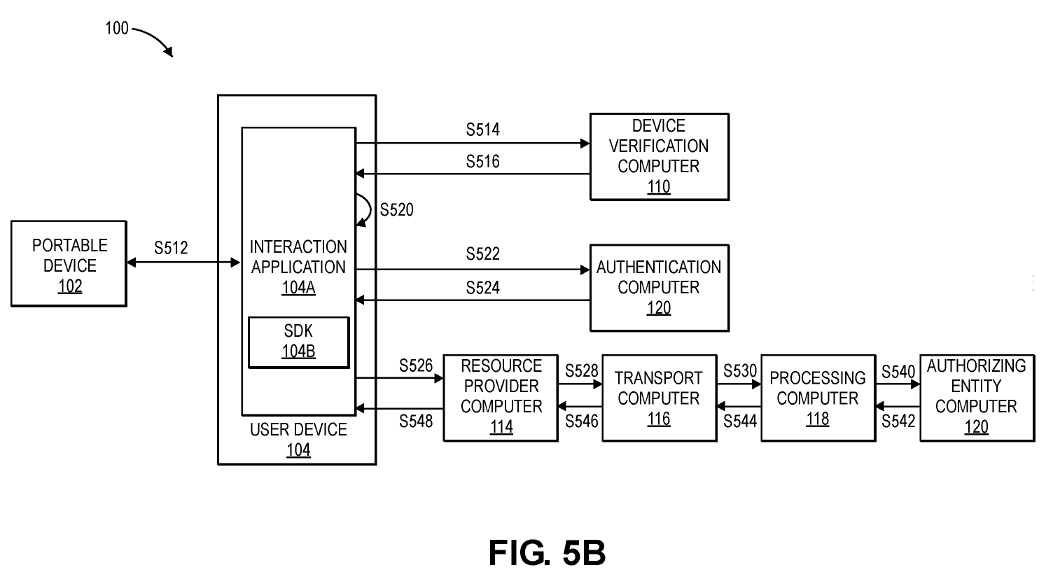

Other embodiments of the invention can be described with reference to FIGS. 5A and 5B. FIG. 5A shows a system and a flow for user device registration. FIG. FIG. 5B shows a system and a flow for conducting a transaction after registration of the user device. In the process flow in FIG. 5B, unlike the process flow in FIG. 1, the portable device 102 does not determine whether or not to transmit the credential based on a received user device identifier.

FIG. 5A shows a portable device 102 and a user device 104 operated by a user. The user device 104 comprises an interaction application 104A, which includes an SDK 104B (software development kit). A device verification computer 110 and an authentication computer 122 are remotely located with respect to the user device 104 and the portable device 102.

In step S502, the user interacts the portable device 102 with the user device 104. The portable device 102 can comprise access data. The access data can be, for example, a credential or token that is in range or group that are specifically designated for use in remote transactions such as e-commerce transactions (as opposed to in person transactions). If the credential or token is not being used in a remote transaction, then a downstream processing computer or authorizing entity computer can decline any authorization request that includes the credential or token. The portable device 102 can transmit access data on the portable device 102 to the user device 104.

In step S504, the SDK 104B in the interaction application 104A in the user device 104 can then provide a user device verification request to the device verification computer 110. The SDK 104B can collect device information such as the model and type of user device 104, the operating system on the user device 104, the type of hardware elements on the user device, etc. This information and possibly other information about the user of the user device (e.g., a name) can be provided in the user device verification request.

In step S506, after receiving the user device verification request, the device verification computer 110 can then verify the integrity of the user device 104 by analyzing the data in the user device verification request. If the device verification computer 110 verifies that the user device 104 is authentic and/or has acceptable processing capabilities and secure, the device verification computer 110 can obtain a user device identifier for the user device 104. In some embodiments, the device verification computer 110 can obtain the user device identifier from a pool of identifiers or it may generate it. In the latter case, information in the user device verification request can be altered (e.g., hashed or encrypted) to form the user device identifier. The device verification computer 110 can associate the user device information for the user device 104 with the user device identifier, and can send the user device identifier to the user device 104.

In step S508, after receiving the user device identifier, the SDK 104B can generate a public-private key pair and can link it to a biometric of the user. The user’s biometric (e.g., a fingerprint, face image, etc.) can be stored in the SDK or elsewhere on the user device 104.

In step S510, the SDK 104B in the user device 104 can transmit the public key of the public-private key pair to the authentication computer 122 along with the access data received by the user device 104 from the portable device 102, and the user device identifier originating from the device verification computer 110. The authentication computer 122 can effectively “whitelist” the access data for the particular user device 104 with the user device identifier, such that these pieces of information are tied to the user’s biometric (or other authentication data).

FIG. 5B shows a resource provider computer 114, a transport computer 116, a processing computer 118 and an authorizing entity computer 120, similar to the system in FIG. 1. In addition, FIG. 5B also shows interaction application 104A on the user device including an SDK (software development kit) 104B. Further, the device verification computer 110 and the authentication computer 122 remotely located with respect to the user device 104 and the portable device 102 are also shown. The method shown in FIG. 5B can be a transaction to obtain a resource from a resource provider operating the resource provider computer 114.

In step S512, the user interacts the portable device 102 with the user device 104, after the user has selected one or more resources to obtain from the resource provider operating the resource provider computer 114 using the interaction application 104A. The portable device 102 can pass the access data on the portable device 102 to the user device 104. The user device 104 can then receive the access data from the portable device 102. In some embodiments, the portable device 102 may be stationary and in proximity to the user device 104, and the NFC reader in the user device 104 can be activated to case it to read data from the portable device 102. Alternatively, the user may manipulate the portable device 102 so that it is near the NFC reader of the user device 104. The process illustrated in FIG. 4, without step S420, can be used to illustrate an exemplary interaction between the portable device 102 and the user device 104.

The SDK 104B can evaluate the access data received from the portable device 102 and can check to see if the access data is associated with a public-private key pair.

In step S514, similar to step S504 in FIG. 5A, the SDK 104B in the interaction application 104A in the user device 104 can then provide a user device verification request comprising the user device identifier to the device verification computer 110. The device verification computer 110 can then verify the integrity of the user device 104 and confirm that it was previously registered by the device verification computer 110.

In step S516, the device verification computer 110 can transmit a user device verification response message indicating that the user device 104 is verified. In some cases, the device verification computer 110 may transmit the user device identifier generated in the process of FIG. 5A to the user device 104 if it is not already stored in the user device 104.

In step S520, in response to receiving the device verification response message, the user device 104 can prompt the user to provide a biometric to the user device 104 to authenticate to the user device 104. The user device 104 can compare the received biometric to a stored biometric to determine if a match is present, and that the user is authenticated. After a positive authentication, the SDK 104B in the user device 104 can retrieve the private key of previously created public-private key pair and can sign information including the access data, the user device identifier, and other information such as the details of the transaction (e.g., a transaction amount) to produce a digital signature. Such information may be concatenated before it is signed. The private key may be an example of a first cryptographic key and the public key may be an example of a second cryptographic key.

In step S522, the user device 520 can then send the digital signature of the information and the information to the authentication computer 122. The authentication computer 122 can verify that the access data and the user device identifier have been previously registered with the authentication computer 122. It can then look up the public key corresponding to the user device identifier and/or the access data. It can then verify the digital signature using the public key, and can then generate an authentication cryptogram (e.g., an AuthN cryptogram) using the information (e.g., the user device identifier, the access data, etc. In some embodiments, the authentication cryptogram can be generated using a symmetric key that is shared with the processing computer 118 or the authorizing entity computer 130. Later, during authorization processing, the processing computer 118 or the authorizing entity computer 130 can verify the authentication cryptogram with the symmetric key. The verification can be proof that the user was properly authenticated for the transaction.

In step S524, the authentication computer 122 can transmit the authentication cryptogram to the interaction application 104A in the user device 104.

In step S526, user device 104 comprising the interaction application 104A may then initiate the sending of an authorization request message comprising the access data and the authentication indicator to an external computer. For example, the interaction application 104A can pass the access data and the authentication cryptogram to the resource provider computer 114. The resource provider computer 114 can then generate an authorization request message comprising the access data, the authentication cryptogram, the transaction amount, and other information and can send or transmit it to the processing computer 118 via the transport computer 116 in steps S528 and S530. The processing computer 118 can then verify the authentication cryptogram using a corresponding cryptographic key to determine if it is valid. If it is, then the processing computer 118 can include a positive authentication indicator in the authorization request message and can then transmit the authorization request message with the access data, the authentication indicator, and the transaction amount to the authorizing entity computer 120. The authorizing entity computer 120 can then decide whether or not to authorize the transaction, and can generate an authorization response message. In steps S542, S544, and S546, the authorizing entity computer 120 can then transmit the authorization response message to the resource provider computer 114 via the processing computer 118 and the transport computer 116.

If the access data in the authorization request message is a token, then the processing computer 118 can de-tokenize the token and modify the authorization request message to include the credential associated with the token. The modified authorization request message can then be transmitted to the authorizing entity computer 120. The authorizing entity computer 120 can then transmit an authorization response message comprising the credential back to the processing computer 118. The processing computer 118 can then re-tokenize the credential and can modify the authorization response message to include the token. The processing computer 118 can then transmit the modified authorization response message back to the resource provider computer 114 via the transport computer 116.

At step S548, the resource provider computer 114 can provide an indication that the transaction was authorized in step S118.

At the end of the day or any other suitable period of time, a clearing and settlement process can occur between the transport computer 116, the processing computer 118, and the authorizing entity computer 120.

The embodiments described with respect to FIG. 5 have a number of advantages. For example, the embodiments of the invention associated with FIG. 5 require the use of a specific user device and a specific portable device before any transaction can be conducted. Embodiments of the invention also can use authentication data such as a biometric to ensure that something that the user is, is provided before the transaction can take place. Thus, a person that illegitimately obtains the access data is not able to use it, unless they have the user device, the portable device, and specific data associated with the user (e.g., a biometric or secret). Thus, the embodiments described with respect to FIG. 5 are secure.

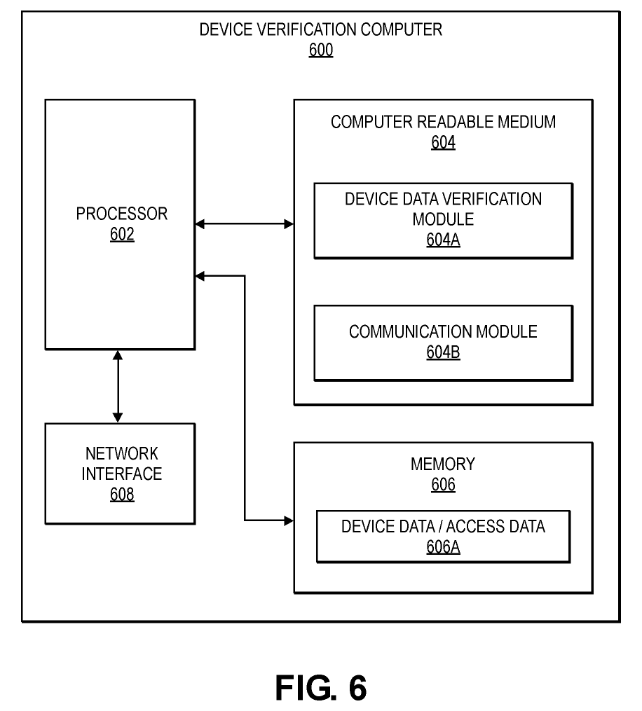

FIG. 6 shows a block diagram showing a device verification computer 600 according to an embodiment. The device verification computer 600 includes a processor 602 and a non-transitory computer readable medium 604, memory 206, and a network interface 608 coupled to the processor 602. The memory 606 can store device data and access data 606A.

The non-transitory computer readable medium 604 may comprise a device data verification module 604A and a communication module 604B. The device data verification module 604A can comprise code, executable by the processor 204 to verify user device data and generate a user device identifier. The communication module 604B may comprise code, executable by the processor 602 to allow the device verification computer 600 to communicate with other devices or computers.

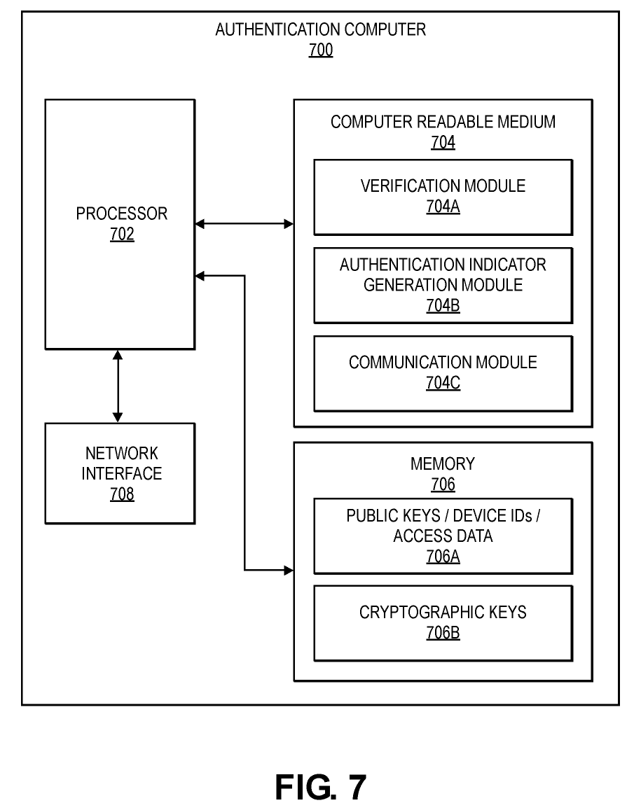

FIG. 7 shows a block diagram showing an authentication computer 700 according to an embodiment. The authentication computer 700 includes a processor 702 and a non-transitory computer readable medium 704, memory 706, and a network interface 708 coupled to the processor 702. The memory 706 can store mappings between public keys, user device identifiers, and access data 706A. The memory 706 can also store cryptographic keys 706B for encryption / decryption and signing / verification processes.

The non-transitory computer readable medium 704 may comprise a verification module 704A, an authentication indicator generation module 704B and a communication module 704C. The verification module 704A can comprise code, executable by the processor 702 to verify digital signatures and to verify data such as access data and user device identifiers. The authentication indicator generation module 704B can comprise code executable by the processor 702 to generate an authentication indicator such as a cryptogram. The communication module 704C may comprise code, executable by the processor 702 to allow the authentication computer 700 to communicate with other devices or computers.

A number of additional embodiments can include the following:

Another embodiment includes a method comprising: providing, by a user device to a portable device comprising access data, a communication comprising user device data, wherein the portable device determines if the user device is authorized to receive the access data; and if the user device is authorized to receive the access data, then receiving, the access data by the user device from the portable device, wherein the user device initiates an interaction with an external computer using the access data

Another embodiment comprises a user device programmed to perform the above method.

Another embodiment comprises a method comprising: receiving, by an authentication computer from a user device, a digital signature of information including access data and a user device identifier, and the information including the access data and the user device identifier; determining, by the authentication computer, a public key associated with the user device identifier or the access data; verifying, by the digital signature using the public key; generating an authentication indicator; and transmitting the authentication indicator to the user device.

Another embodiment comprises an authentication computer programmed to perform the above method.

Embodiments of the invention provide a number of advantages. Embodiments of the invention can improve the security of transactions, by ensuing that only access data that are associated with a particular user device and/or application are used to conduct transactions.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of "a," "an," or "the" is intended to mean "at least one," unless specifically indicated to the contrary.

What is claimed is:

1. A method comprising:
receiving, by a portable device comprising access data from a user device, a communication comprising user device data;
determining, by the portable device using the user device data received from the user device, whether the user device is authorized to receive the access data; and
if the user device is authorized to receive the access data, then providing, by the portable device the access data to the user device, wherein the user device initiates an interaction with an external computer using the access data.

2. The method of claim 1, wherein the portable device stores the user device data and determines if the stored user device data matches the user device data received from the user device.

3. The method of claim 2, wherein the user device data comprises a user device identifier.

4. The method of claim 1, wherein the user device data is a digital signature, and wherein the method further comprises verifying the digital signature using a cryptographic key.

5. The method of claim 1, wherein the user device is a phone and the portable device is a card.

6. The method of claim 5, wherein the card is a driver’s license, a payment card, or government issued ID card.

7. The method of claim 1, wherein the user device is a mobile phone.

8. A portable device comprising:
a processor; and
a computer readable medium coupled to the processor, the computer readable medium comprising access data. and code executable by the processor for performing operations comprising:
receiving, from a user device, a communication comprising user device data;
determining, using the user device data received from the user device, whether the user device is authorized to receive the access data; and
if the user device is authorized to receive the access data, then providing the access data to the user device, wherein the user device initiates an interaction with an external computer using the access data.

9. The portable device of claim 8, wherein the access data comprises a credential.

10. The portable device of claim 8, wherein the portable device is a card.

11. The portable device of claim 8, wherein the user device is a mobile phone.

12. The portable device of claim 8, further comprising a contactless element coupled to the processor, and the contactless element is configured to communicate using NFC (near field communications).

13. The portable device of claim 8, wherein the portable device is a card with the access data embossed on the portable device.

14. A method comprising:
receiving, by a user device comprising an application from a portable device, access data;
signing, by the user device, information including the access data using a first cryptographic key associated with a key pair to obtain a digital signature;
transmitting, by the user device to an authentication server computer, the digital signature and the information including the access data, wherein the authentication server computer verifies the digital signature with a second cryptographic key;
receiving, by the user device, from the authentication server computer, an authentication indicator; and
initiating, by the user device, the sending of an authorization request message comprising the access data and the authentication indicator to an external computer.

15. The method of claim 14, wherein the access data comprises a credential.

16. The method of claim 14, wherein the application comprises an SDK (software development kit).

17. The method of claim 14, wherein the user device is a mobile phone and the first cryptographic key is a private key and the second cryptographic key is a public key.

18. The method of claim 14, wherein the portable device is a card.

19. The method of claim 14, wherein the user device is a mobile phone.

20. The method of claim 14, wherein the information further comprises a user device identifier associated with the user device, and wherein the authentication server computer also verifies that the user device identifier and the access data, and wherein the authentication server computer generates the authentication indicator.
